(19) United States
(12) Patent Application Publication
(10) Pub. No.: US 2006/0095546 A1
(43) Pub. Date: May 4, 2006

(54) Method and system for locating services in proximity networks for legacy application

(75) Inventors: Mika Saaranen, Tampere (FI); Veijo Romppainen, Oulu (FI); Arto Suomi, Tampere (FI); Claus Pedersen, Vallensbaek N (DK); Claus Peter Nielsen, Copenhagen (DK)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/960,152

(22) Filed: Oct. 7, 2004

(51) Int. Cl. G06F 15/177

(52) U.S. Cl. 709/220

(57) ABSTRACT

A system and method for maintaining the configuration of a server within a network. After daemons are initiated, it is determined whether network interfaces are available. If network interfaces are available the available network interfaces are automatically configured. It is then determined whether infrastructure exists. If no infrastructure is detected, then an enhanced socket operation is initiated until a router advertisement is received. Once a router advertisement is received, available network interfaces are configured as necessary.

### FIELD OF THE INVENTION

The present invention relates generally to electronic devices with short-range communication capabilities, such as WLAN and BlueTooth capabilities. More particularly, the present invention relates to electronic devices with enhanced functionality on the devices' socket implementation.

### BACKGROUND OF THE INVENTION

Society is continuously becoming increasingly well-networked and equipped with various devices that may establish local networks. More and more people also carry portable devices, such as mobile phones and personal digital assistants (PDAs), that provide users with personal connectivity and control services.

A Spontaneous network is one type of ad hoc network, but spontaneous networks do not necessarily need multiple hop routes to reach other peers. A hop is defined as a logical connection between two nodes without any opto-electronic processing at intermediate devices. In a single-hop topology, optical signals carry information from a source node to the destination node without undergoing any opto-electronic conversion. Spontaneous networks without multihop represent a simplified scenario where the emphasis is on creating an optimal user experience and solving problems due to missing infrastructure services. In this environment, several kind of terminals may exist and may be equipped with several radios.

In one scenario, a terminal is equipped with short-range radio, such as a wireless local area network (WLAN) or Bluetooth connection, in addition to cellular bearers. The terminal is constantly connected to cellular bearers that allow Internet or voice communication to occur whenever needed. The short-range radio provides additional means of using local services over local area networks. Other situations may involve a multi-hop ad hoc environment, although a single-hop scenario is primarily discussed herein.

In the single-hop scenario, the terminal normally does not convey traffic from a wide area network (WAN) to a local area network (LAN) environment, and hence it does not act as a router. When local services are to be used, the short-range radio is activated, which consequently configures itself automatically for the current network. Even if this radio interface is continuously active, it needs to determine the proper network configuration when entering a new network.

The automatic configuration of the network is not sufficient for an optimal user experience. The user wishes to locate peers and services that are available nearby. It would be desirable to use the service location protocol to locate peers based on a set of predetermined parameters and returning a set of services that is considered to be capable of fulfilling the user's wishes. Typically, in a spontaneous network, many services are needed for this to properly function. However, items such as domain name services and applications servers are missing.

In ad hoc networks, which can be either multi-hop manet type networks or spontaneous networks, there is a very limited infrastructure, if any infrastructure exists at all. As most of the applications in the Internet do expect certain services to be available, the ad hoc environment causes problems in their function. For example, domain name services do not function and IP addresses of services may not be correct. It can also be difficult to locate available services. These problems can be the most severe on legacy applications that are made for Internet operation and do not have features for helping them in an ad hoc environment.

### SUMMARY OF THE INVENTION

The present invention addresses the issues identified above by having all terminals equipped with a number of application server functionalities. For example, most mobile phones are equipped with web servers according the principles of the present invention, providing a user with specific weblog service. In addition to local servers, legacy applications that are not built with an ad hoc environment in mind require additional assistance. Legacy applications include problems such as converting domain names into IP addresses, which is a basic service of infrastructured networks.

The present invention addresses this issue by adding new functionality on the terminal's socket implementation. When a legacy application opens a network socket, this initiates service discovery and an ad hoc network compatible DNS/IP service. The purpose of this enhanced functionality is to provide a valid server and IP address for the legacy application without requiring changes into it.

The present invention possesses a number of advantages over the prior art. The present invention can be incorporated into a wide variety of electronic devices, including, but not limited to most cellular terminals and/or personal digital assistants. The present invention permits the same applications to be used in both network infrastructure and within ad hoc networks. Furthermore, one could also provide Java API with the present invention, which provides application developers with new ways of creating widely functional applications with a number of potentially powerful new features.

One embodiment of the present invention involves a method of maintaining the configuration of a server within a network. After daemons are initiated for the server, it is determined whether network interfaces are available. If network interfaces are available, the available network interfaces are configured. It is then determined whether infrastructure exists. If no infrastructure is detected, an enhanced socket operation is initiated until a router advertisement is received in order to continue to configure the available network interfaces as necessary. Other embodiments of the invention relate to computer software programs, electronic devices, modules and mobile terminals that are capable of accomplishing these steps.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a logical architecture incorporating the principles of the present invention;

FIG. 2 is a flow chart showing the operation of an electronic device according to one embodiment of the present invention;

FIG. 3 is an overview diagram of a system according to the present invention;

FIG. 4 is a perspective view of a mobile telephone that can be used in the implementation of the present invention; and

FIG. 5 is a schematic representation of the telephone circuitry of the mobile telephone of FIG. 4;

### DETAILED DESCRIPTION OF THE PREFERRED EMBODIMENTS

According to the principles of the present invention, the socket API of an electronic device is modified to detect when the interface in question is in an ad hoc network mode. If the interface is not in an ad hoc network mode, the operation continues normally as occurs in conventional systems. If the interface is in an ad hoc network mode, however, then the opening of a socket results in a check of the address type. If the address is not a local address, then name resolution or service discovery is initiated. The local address is provided according the Ipv6 link local address (part of fe80::/10 address space) or Ipv4 using 169.x.x.x according to one embodiment of the invention.

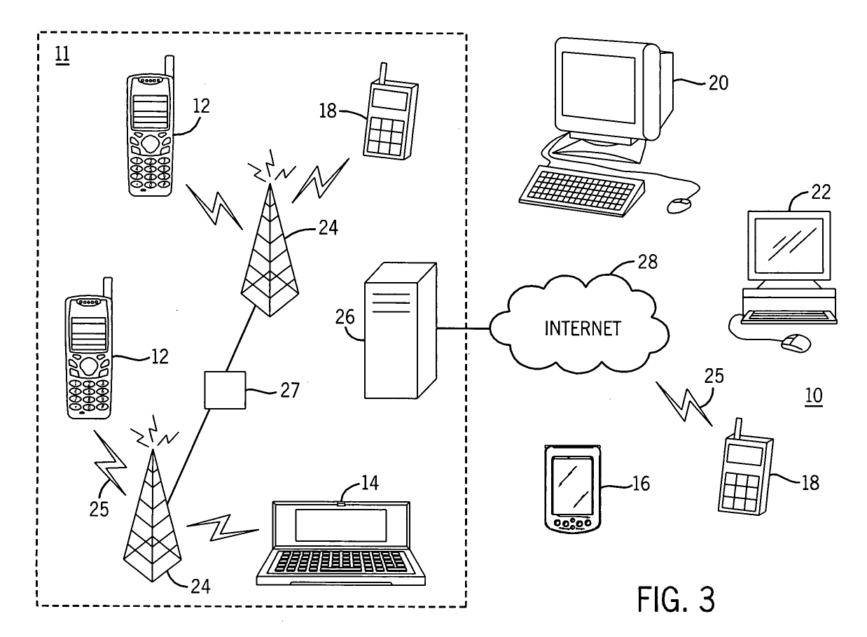

FIG. 3 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 3 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an IMD 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

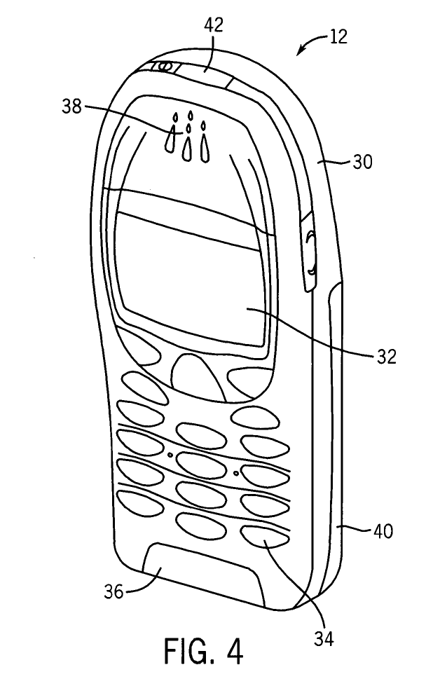

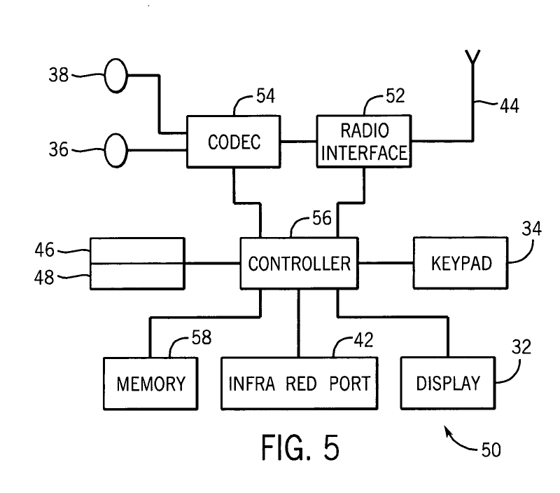

FIGS. 4 and 5 show one representative portable telephone 12 according to one embodiment of the invention. However, it should be understood that the present invention is not intended to be limited to one particular type of portable telephone 12 or other electronic device. The portable telephone 12 of FIGS. 4 and 5 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a card reader 48, and mobile telephone circuitry 50. The mobile telephone circuitry 50 includes radio interface circuitry 52, coded circuitry 54, a controller 56 and a memory 58. Individual circuits and elements are all of a type well known in the art, for example in the Nokia range of mobile telephones.

For service discovery, the type of the socket that is to be opened is determined based upon well known TCP/UDP ports (from e.g. IANA) is determined, and known port types can also be added based on specific applications. Based on this information, service discovery can be restricted to most potential services. This may also be a configurable feature. When results arrive, the user can be provided with the possibility to select between found services.

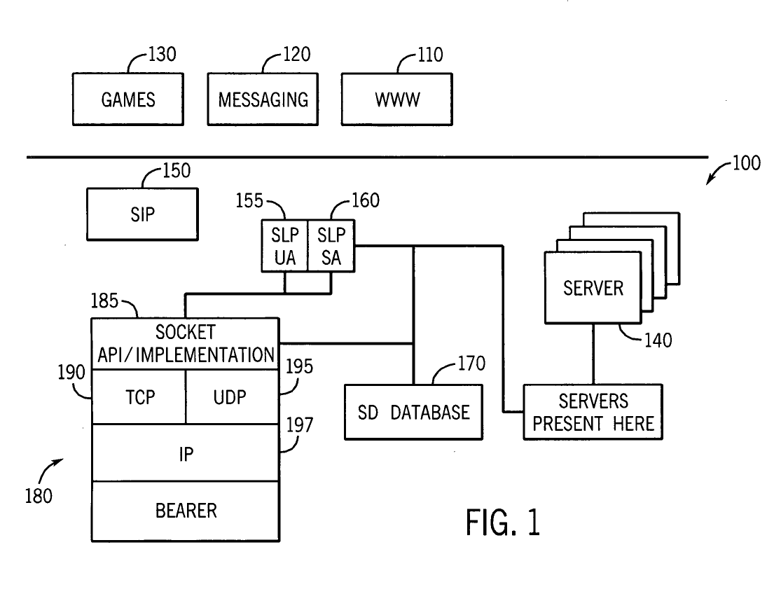

The present invention is based primarily on existing IETF specified solutions that are extended in order to enable legacy application support and to make user interaction as easy as possible. A logical architecture according to one embodiment of the present invention is shown in FIG. 1. This architecture is shown generally at 100 and includes the following components. Closest to the user are applications that may be spontaneously network-aware, but typically take the form of typical Internet applications. These unmodified applications are expected to be found in a normal Internet-like environment and include, but are not limited to, the world wide web 110, messaging systems 120 and games 130.

Application servers 140 are usually located somewhere in the infrastructured Internet. Because one cannot rely on having network connectivity to these servers, some of these application server functionalities are placed into mobile terminals. Server functionalities, such as HTTP server functionality, are not very processing and communication-intensive, if only a few connections are served at the time. Other servers, such as chat and gaming servers, could be part of the mobile terminal.

The terminal may have several application-level protocols such as session initiation protocol (SIP) 150. These protocols are used by applications such as chatting or gaming. Service discovery, namely Service Location Protocol (SLP), is a significant part of the architecture. In other embodiments of the invention, other service discovery protocols besides SLP could be used. In mobile terminals, there are two functions. First, a SLP user agent 155 is used to locate services and peers on the proximity network. The SLP user agent receives its assignments from applications or from the modified protocol stack. SLP service agents 160 keep record of the terminal's own services. In practice, the earlier mentioned application servers provide these services. The record is called the service discovery database 170 and can also be used by service agents.

The final architectural piece is the TCP/IP protocol suite, shown generally at 180. The actual protocol implementation is standard using an automatic configuration of the network interface. The present invention is primarily focused on the socket interface implementation. These changes cause the socket interface 185 to check the current network status for an interface and to request service discovery when needed. Other components include the transmission control protocol (TCP) 190 and the internet protocol (IP) 195.

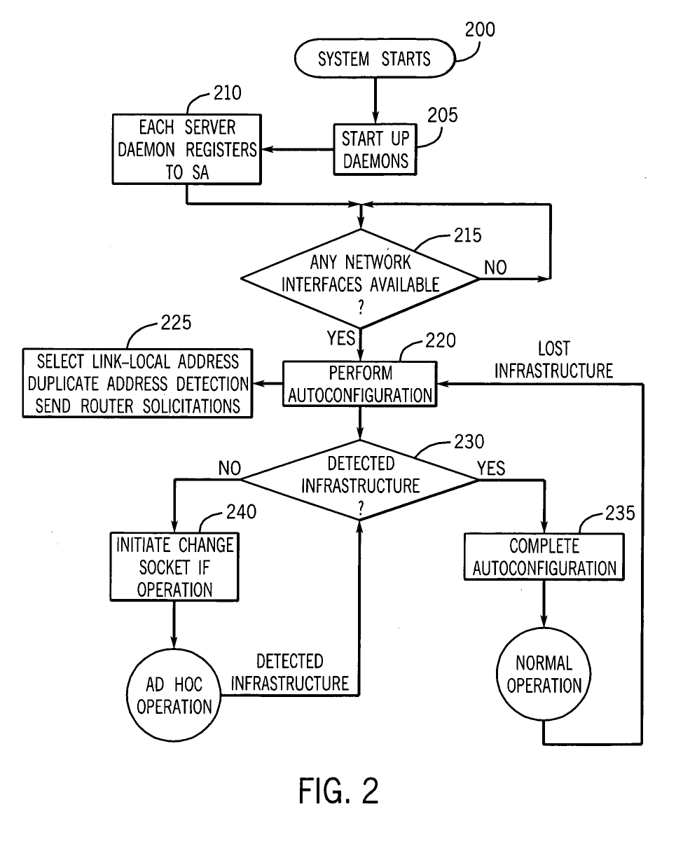

FIG. 2 is a diagram of the terminal's normal operation according to one embodiment of the present invention. At step 200 the system is started. At step 205, all daemons are initiated. As part of the server start-up, the server registers itself to an INET daemon and, in some cases, also registers itself separately to service agents at step 210. It is then determined at step 215 whether network interfaces are available. The following step involves the configuration of all network interfaces at step 220. During the activation, normal autoconfiguration is performed. This also includes at step 225 the creation of link local address and performing duplicate address detection. This also occurs when new interfaces are activated at a later time. In the next step at step 230, the terminal detects whether infrastructure exists. This is accomplished by either by sending router solicitations or by listening to router advertisements. If infrastructure is detected, the terminal operates as it otherwise would in a normal Internet environment and completes the autoconfiguration at step 235. If the infrastructure is lost, on the other hand, autoconfiguration must be re-initiated. If no infrastructure exists on this specific interface, the enhanced socket operation is initiated at step 240 and continues until a router advertisement is received and the operation of the terminal returns to IP autoconfiguration.

In a “spontaneous” mode, which is detected by the interface and can be detected if only a link local address exists, opening a socket results additional operations before the actual connection can be established. If the address of the open request can be found from the service discovery data base and the address is not a global address, the terminal may proceed to establish a connection. If no valid entry exists, the next phase involves whether the address is a local address or a global address. If it is a DNS name, one must perform multicast DNS messages to determine the IP address. If this is a local address, one may proceed to connection establishment. For global addresses, a service discovery is performed. If the socket type is registered, only specific services can be discovered. If the service type is not known, an open service discovery is performed. Finally, user is always given possibility to choose among found services.

While several embodiments have been shown and described herein, it should be understood that changes and modifications can be made to the invention without departing from the invention in its broader aspects. For example, but without limitation, the present invention could be incorporated into a wide variety of electronic devices, such as cellular telephones, personal digital assistants, and other devices. Various features of the invention are defined in the following Claims.

What is claimed is:

1. A method of maintaining the configuration of a server within a network, comprising the steps of:
initiating daemons for the server;
determining whether network interfaces are available;
if network interfaces are available, configuring the available network interfaces;
determining whether infrastructure exists; and
if no infrastructure is detected, initiating an enhanced socket operation until a router advertisement is received in order to continue to configure the available network interfaces as necessary.

2. The method of claim 1, wherein the step of initiating daemons includes registering each daemon to at least one service agent.

3. The method of claim 1, wherein the determination of whether infrastructure exists includes transmitting router solicitations to routers within the network.

4. The method of claim 1, wherein the determination of whether infrastructure exists includes listening to router advertisements on the network.

5. The method of claim 1, wherein the step of configuring the available network interfaces includes creating a link local address and performing duplicate address detection.

6. The method of claim 1, further comprising the step of, if infrastructure exists, continuing to configure available network interfaces as necessary.

7. The method of claim 1, wherein the initiation of daemons includes having the server register itself to an INET daemon.

8. The method of claim 1, wherein the enhanced socket operation includes transmitting a multicast DNS message to determine an IP address.

9. A computer program product for maintaining the configuration of a server within a network, comprising:
computer code for initiating daemons for the server;
computer code for determining whether network interfaces are available;
computer code for, if network interfaces are available, configuring the available network interfaces;
computer code for determining whether infrastructure exists; and
computer code for, if no infrastructure is detected, initiating an enhanced socket operation until a router advertisement is received in order to continue to configure the available network interfaces as necessary.

10. The computer program product of claim 9, wherein the initiation of daemons includes registering each daemon to at least one service agent.

11. The computer program product of claim 9, wherein the determining of whether infrastructure exists includes transmitting router solicitations to routers within the network.

12. The computer program product of claim 9, wherein the determining of whether infrastructure exists includes listening to router advertisements on the network.

13. The computer program product of claim 9, wherein the configuring of the available network interfaces includes creating a link local address and performing duplicate address detection.

14. The computer program product of claim 9, further comprising computer code for, if infrastructure exists, continuing to configure available network interfaces as necessary.

15. The computer program product of claim 9, wherein the initiation of daemons includes having the server register itself to an INET daemon.

16. The computer program product of claim 9, wherein the enhanced socket operation includes transmitting a multicast DNS message to determine an IP address.

17. A server for transmitting information, comprising:
a processor for processing information;
a data communication link for communicating with devices within a network; and
a memory unit storing a computer program product and including:
computer code for initiating daemons for the server,
computer code for determining whether network interfaces are available,
computer code for, if network interfaces are available, configuring the available network interfaces,
computer code for determining whether infrastructure exists, and
computer code for, if no infrastructure is detected, initiating an enhanced socket operation until a router advertisement is received in order to continue to configure the available network interfaces as necessary.

18. The server of claim 17, wherein the initiating of daemons includes registering each daemon to at least one service agent.

19. The server of claim 17, wherein the determining of whether infrastructure exists includes transmitting router solicitations to routers within the network.

20. The server of claim 17, wherein the determining of whether infrastructure exists includes listening to router advertisements on the network.

21. The server of claim 17, wherein the configuring of the available network interfaces includes creating a link local address and performing duplicate address detection.

22. The server of claim 17, further comprising computer code for, if infrastructure exists, continuing to configure available network interfaces as necessary.

23. The server of claim 17, wherein the initiation of daemons includes the step of having the server register itself to an INET daemon.

24. The server of claim 17, wherein the enhanced socket operation includes the step of transmitting a multicast DNS message to determine an IP address.

25. A module for communicating with a plurality of devices in a network, comprising:
a processor for processing information; and
a memory unit storing a computer program product and including:
computer code for initiating daemons for the module,
computer code for determining whether network interfaces are available,
computer code for, if network interfaces are available, configuring the available network interfaces,
computer code for determining whether infrastructure exists, and
computer code for, if no infrastructure is detected, initiating an enhanced socket operation until a router advertisement is received in order to continue to configure the available network interfaces as necessary.

26. The module of claim 25, wherein the initiating of daemons includes registering each daemon to at least one service agent.

27. The module of claim 25, wherein the determining of whether infrastructure exists includes transmitting router solicitations to routers within the network.

28. The module of claim 25, wherein the determining of whether infrastructure exists includes listening to router advertisements on the network.

29. The module of claim 25, wherein the configuring of the available network interfaces includes creating a link local address and performing duplicate address detection.

30. The module of claim 25, further comprising computer code for, if infrastructure exists, continuing to configure available network interfaces as necessary.

31. The module of claim 25, wherein the initiation of daemons includes the step of having the server register itself to an INET daemon.

32. The module of claim 25, wherein the enhanced socket operation includes the step of transmitting a multicast DNS message to determine an IP address.

33. A mobile terminal, comprising:
a processor for processing information;
a data communication link for providing communications capability for the mobile terminal within a network; and
a memory unit storing a computer program product, the memory unit operatively connected to the processor and including:
computer code for initiating daemons for the mobile terminal,
computer code for determining whether network interfaces are available,
computer code for, if network interfaces are available, configuring the available network interfaces,
computer code for determining whether infrastructure exists, and
computer code for, if no infrastructure is detected, initiating an enhanced socket operation until a router advertisement is received in order to continue to configure the available network interfaces as necessary.
